(19) United States
(12) Patent Application Publication
(10) Pub. No.: US 2018/0244357 A1
(43) Pub. Date: Aug. 30, 2018

(54) Strap-Supported Cup and Article Holder

(71) Applicant: Roy Quinton Bouse, Port Bolivar, TX (US)

(72) Inventor: Roy Quinton Bouse, Port Bolivar, TX (US)

(21) Appl. No.: 15/963,363

(22) Filed: Apr. 26, 2018

Related U.S. Application Data
(63) Continuation of application No. 14/704,906, filed on May 5, 2015.
Application No. 14/704,906 is a continuation-in-part of application No. 13/670,760, filed on Nov. 7, 2012, now abandoned.

(51) Int. Cl. B63B 35/85; B65D 25/04; B65D 43/14; B65D 25/22; F16B 2/08; F16M 13/02

(52) U.S. Cl. CPC B63B 35/85; B65D 25/04; B65D 43/14; F16M 13/022; B65D 25/22; F16B 2/08

(57) ABSTRACT

A strap-supported beverage and article holding assembly. The present invention includes a support that is removably securable to a support article, such as an inner tube, and a beverage and article holder that is adapted to removably engage with the support. The removable connection between the holder and the support maintains the holder in an upright orientation, regardless of the orientation in which the support is attached to the support device. In various embodiments of the present invention, the removable connection comprises a tab extending from the strap that engages with a complementary slot disposed on the holder, complementary magnets, and other such types of removable connectors. The housing of the holder further includes a secondary compartment or receptacle. The secondary receptacle can be disposed about the exterior surface of the holder and can include a lid for preventing the entry of water into the interior volume thereof.

### CROSS REFERENCE TO RELATED APPLICATION

This application is a continuation-in-part of U.S. patent application Ser. No. 13/670,760 filed on Nov. 7, 2012. The above identified patent application is herein incorporated by reference in its entirety to provide continuity of disclosure.

### FIELD OF THE INVENTION

The present invention relates to a modular article support that is securable in any orientation to an object. More specifically, the present invention relates to a drink or beverage holder that is securable to an inner tube or other water float, which has a strap connector to which the holder is removably securable.

### BACKGROUND OF THE INVENTION

Many individuals enjoy lounging on floating tubes in a pool. This activity allows the individual to enjoy the weather, sunbathe, and relax while sitting in a support float. These tubes and floating devices are provided in numerous shapes, sizes and configurations; however, not all are constructed having built-in cup or article holders that allow a user to rest a beverage, a pack of cigarettes or a cell phone safely therein while on the float and in the pool. Without such support, the user is required to manually hold the article while floating, or rest it along the side of the pool and paddle over to its location when retrieval is desired.

### SUMMARY OF THE INVENTION

In view of the foregoing disadvantages inherent in the known types of beverage and articles holders now present in the prior art, the present invention provides a new beverage and article holder wherein the same can be utilized for providing convenience for the user when attaching a beverage and article holder to either a horizontal or vertical support member. The present invention comprises a support that is removably securable to a support article, such as an inner tube, and a beverage and article holder that is adapted to removably engage with the support. The removable connection between the holder and the support maintains the holder in an upright orientation, regardless of the orientation in which the support is attached to the support device. In various embodiments of the present invention, the removable connection comprises a tab extending from the strap that engages with a complementary slot disposed on the holder, complementary magnets, and other such types of removable connectors.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the present invention secured to an inner tube and a call out for the holder of the present invention.

FIG. 2 shows a perspective view of the backside of the present invention.

FIG. 3 shows a perspective view of the backside of an alternative embodiment of the present invention comprising multiple sets of strap apertures.

FIG. 4 shows a perspective view of an alternative embodiment of the present invention comprising a rear-mounted receptacle.

FIG. 5 shows a perspective view of an alternative embodiment of the present invention comprising a magnetic connector.

### DETAILED DESCRIPTION OF THE INVENTION

Reference is made herein to the attached drawings. Like reference numerals are used throughout the drawings to depict like or similar elements of the strap-supported article holder. For the purposes of presenting a brief and clear description of the present invention, the preferred embodiment will be discussed as used for supporting a beverage and other articles using a strap connector around supports of various type and orientation. The figures are intended for representative purposes only and should not be considered to be limiting in any respect.

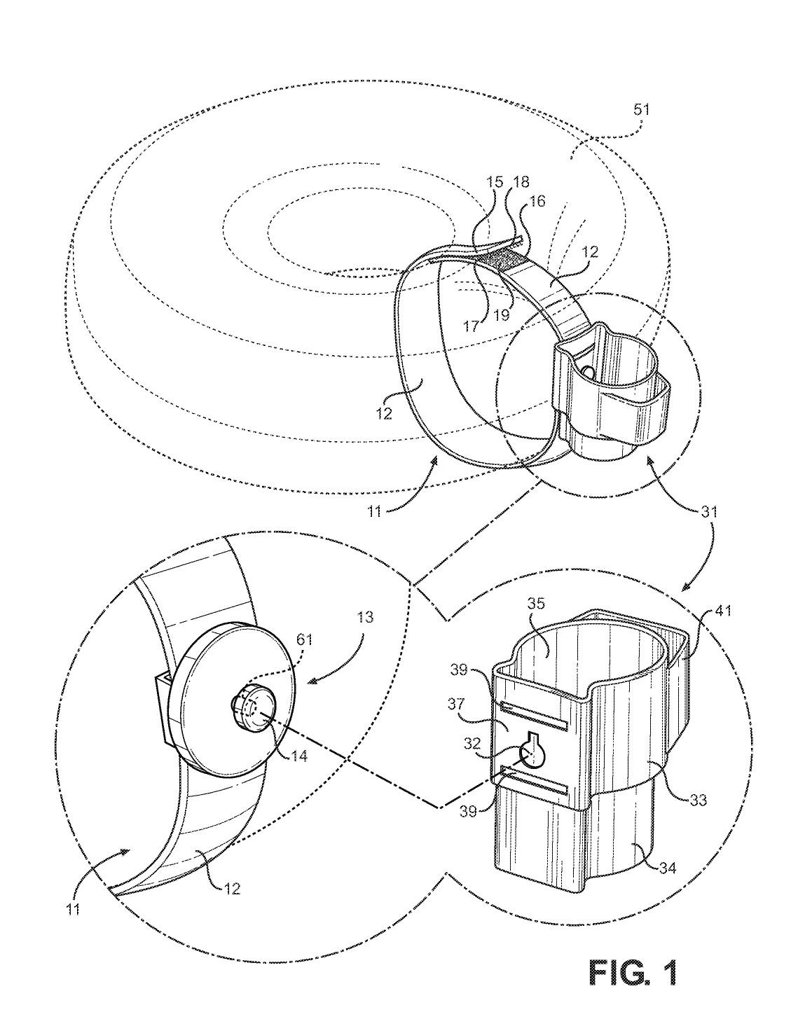

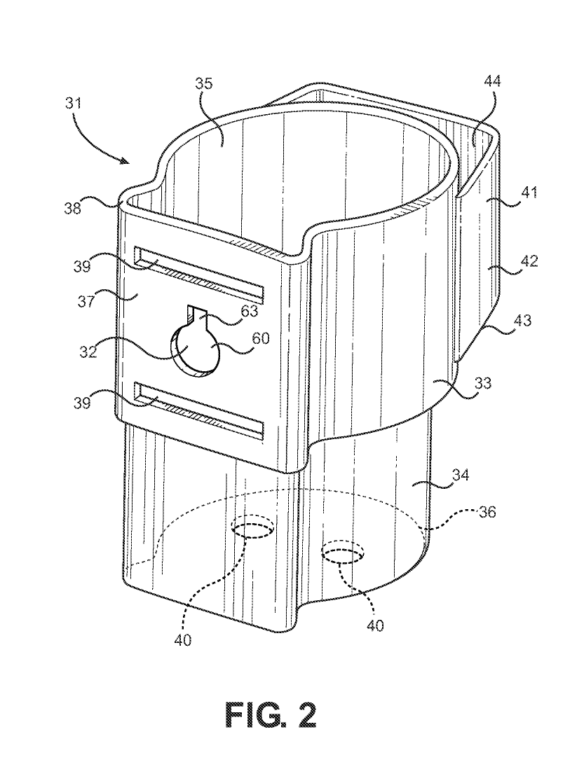

Referring now to FIGS. 1 and 2, there are shown perspective views of the present invention secured to an inner tube and a call out for the holder of the present invention and of the backside of the present invention. The present invention comprises a support 11, which is removably attachable to a support article, and a separate holder 31, which is adapted to hold beverages and other articles. The holder 31 comprises a rounded or cylindrical housing to accept items therein having an upper portion 33, a lower portion 34, an open upper end 35, and a base 36. In one embodiment of the present invention, the sidewalls of the upper and lower portions 33, 34 of the holder 31 are tapered or stepped to accommodate beverage containers of differing size and shape, i.e. the diameter of the lower portion 34 is less than the diameter of the upper portion 33. In another embodiment of the present invention, the cylindrical housing of the holder 31 has a uniform shape, lacking separately defined upper and lower portions 33, 34. The holder 31 comprises an outer surface and a backside surface 37, which includes a holder connector adapted to removably engage with the connector disposed on the strap. In an alternative embodiment of the present invention, the backside surface 37 includes at least two apertures 39 through which a strap can be weaved in order to serve as a supplemental means for securing the holder 31 to a support article, such as an inner tube 51, in lieu of utilizing the connector to the support 11. In an illustrative embodiment of the present invention, the backside surface 37 is an extended, flat surface offset 38 from the arc or perimeter of the cylindrical housing, providing a flush, offset surface to place against a supporting surface. In the depicted embodiment of the present invention, the backside surface 37 is planar; however, in alternative embodiments of the present invention, the backside surface 37 has a curvature corresponding to the curved surfaces of various items to which the present invention is adapted to be secured. The curvature of the backside surface 37 allows the present invention to rest flush against the curved surfaces of these objects when in use.

The support 11 comprises a strap 12 having a connector 13 extending therefrom, wherein the connector 13 is adapted to removably engage the holder 31 in order to hold the holder 31 in an upright orientation. The strap 12 provides an encircling connector that wraps around an exposed portion of the support article, e.g. an inner tube 51. The strap 12 comprises a first end 15, a second end 16, and a strap connector 17 disposed at the first and second ends 15, 16. In an illustrative embodiment of the present invention, the strap connector 17 comprises a first mating surface 18 and a complementary second mating surface 19 of hook-and-loop fastening material. In alternative embodiments of the present invention, the strap connector 17 comprises clips or other such removable connectors. The strap connector 17 can be adjustable or the material of the strap 12 can be elastic to offer increased compression of the support article 51 as required by the weight of the articles within the holder 31.

The holder 31 further comprises an accessory or secondary receptacle 40 disposed along the exterior surface of the holder 31. This secondary receptacle 40 provides an additional enclosed container for articles. The secondary receptacle 40 comprises a sidewall 42, a base 43, and an open upper end 44 through which articles can be placed into the interior volume of the secondary receptacle 40. The secondary receptacle 40 is adapted to store accessory articles such as food or cellular phones, or alternatively may form a repository for cigarette ash. It is contemplated that this accessory container may be positioned along any portion of the exterior surface of the holder 31, including opposite of the backside surface 37 or along the sides of the housing of the holder 31 perpendicular thereto.

The connector 17 is adapted to removably secure the holder 31 to the support 11, such that the holder 31 is securable in an upright orientation regardless of the orientation in which the support 11 is secured to the support article. In an illustrative embodiment of the present invention, the connector 17 comprises a tab 14 extending from the strap 12 that is sized and shape to engage with a slot 32 disposed on the backside surface 37 of the holder 31. The tab 14 is offset from the strap 12 via a neck 61. The slot 32 comprises a main section 62 that is sized and shaped to accept the tab 14 therethrough and a secondary section 63 extending from the upper portion of the main section 62. When the tab 14 is inserted through the slot 32, the neck 63 rests within the secondary section 63 of the slot 14 and the weight of the holder 31 is supported thereon. The size or shape of the secondary section 63 prevents the tab 14 from being withdrawn therethrough, ensuring that the holder 31 is secured in place when secured thereto. If the user wishes to remove the holder 31 from the support 11, then the user can lift the holder 31 vertically and then withdraw the holder 31 from the tab 14 of the support 11 through the main section 62 of the slot 14.

In an alternative embodiment of the present invention, the holder 31 further comprises two or more apertures 39 disposed on the backside surface 37 that can be used to secure the holder 31 to a support article via a strap, in lieu of the use of the support 11. In an illustrative embodiment of the present invention, the apertures 39 comprises a first and second aperture 39 vertically spaced from one another to accept a strap therethrough in a vertical orientation. In this configuration, the strap is positioned to encircle a horizontal member, where the strap is wrapped vertically therearound and in parallel with the upstanding orientation of the article holder housing.

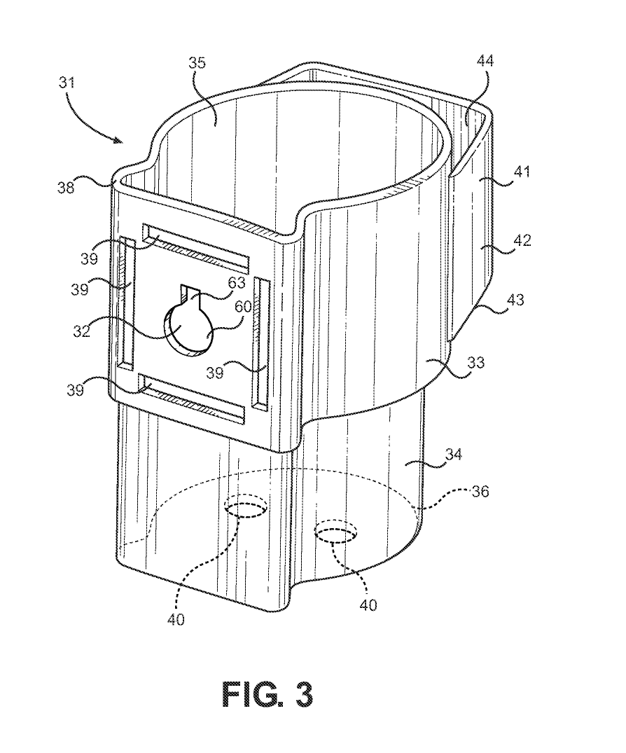

Referring now to FIG. 3, there is shown a perspective view of the backside of an alternative embodiment of the present invention. This alternative embodiment of the present invention comprises two sets of apertures, rather than one set of apertures as discussed above. The first set of apertures 39 includes a pair of vertically spaced apertures 39, which allows a strap to be positioned vertically through the backside surface 37. The second set of apertures 39 includes a pair of horizontally spaced apertures 39, which allow a strap to be positioned horizontally through the backside surface 37. This configuration allows a strap to be orientated in either a vertical or horizontal direction, as required by the user to connect the holder 31 to either a vertical support or horizontal support. This expands the number of applicable supports to which the holder 31 can be secured, while still ensuring that the holder 31 and any articles housed therein are secured in an upright configuration.

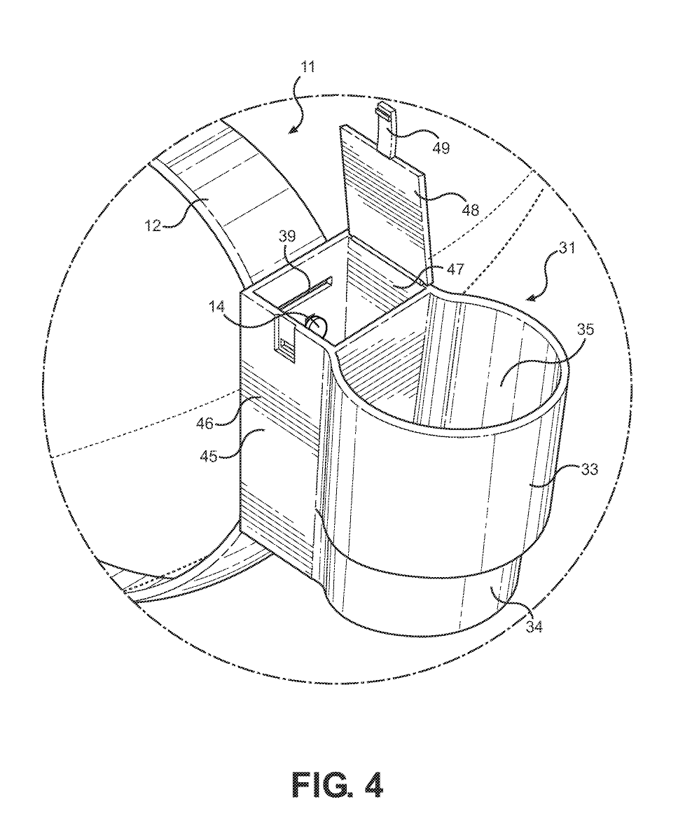

Referring now to FIG. 4, there is shown a perspective view of an alternative embodiment of the present invention. This alternative embodiment of the present invention further includes a rear-mounted receptacle 45 disposed between the backside surface 37 and the cylindrical housing, which includes the upper and lower portions 33, 34, of the holder 31. The rear-mounted receptacle 45 comprises a sidewall 46, a base, and an open upper end 47, forming a partially enclosed interior volume. The rear-mounted receptacle is sealable with a water tight lid 48 that is secured over the open upper end 47 using a lid connector element 49. This allows the user to place sensitive or electronic devices into the interior volume of the rear-mounted receptacle 45 without fear of having them water damaged, particularly when the present invention is utilized in conjunction with a pool float. As with the previous embodiments, the holder 31 can be secured to a support article utilizing the complementary support 11 that removably engages therewith or by feeding a strap through apertures 39 disposed along the backside surface 37 of the device. In the water-resistant embodiment, the backside surface 37 and strap apertures 39 are offset from the backside of the container 31 such that no through-holes are present in the rear-mounted container that would otherwise breach the watertight integrity of the rear-mounted receptacle 45.

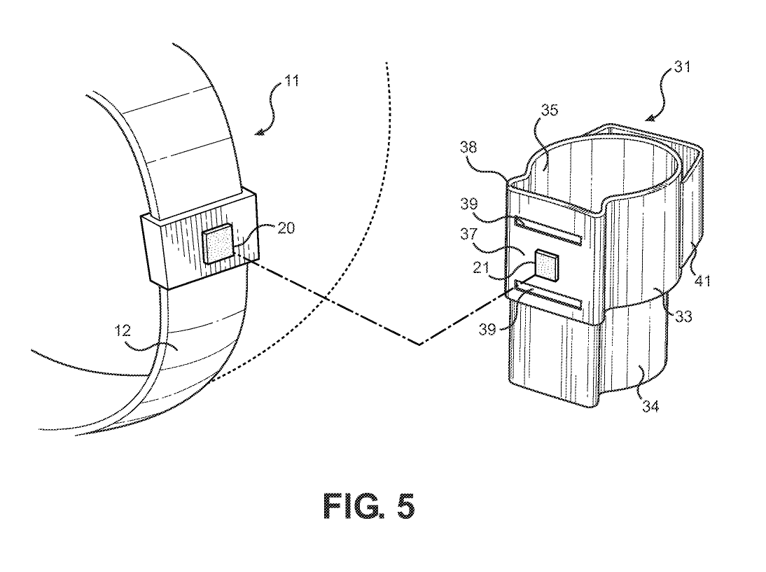

Referring now to FIG. 5, there is shown a perspective view of an alternative embodiment of the present invention comprising a magnetic connector. In this alternative embodiment of the present invention, the connector 17 comprises a first magnet 20 disposed on the strap 12 and a complementary second magnet 21 disposed on the backside surface 27 of the holder 31. As with the embodiment of the connector 17 described above, this embodiment of the connector 17 allows the holder 31 to be attached to the support 11 in an upright orientation, regardless of the orientation in which the support 11 is attached to a support article.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An article holding assembly, comprising:
a holder comprising a rounded housing, an interior volume, an open upper end, a base, an exterior surface, and a planar backside surface;
the housing comprising a non-uniform diameter;
a secondary receptacle extending from the housing, the secondary receptacle comprising a sidewall, a base, and an open upper end;
wherein the base of the secondary receptacle, the sidewall of the secondary receptacle, and the housing of the holder form a contiguous surface defining an interior volume;
a support comprising a strap that is securable around a support article;
a connector adapted to removably secure the holder to the support such that that holder is held in an upright orientation regardless of the orientation in which the support is secured to the support article.

2) The article holding assembly of claim 1, wherein the connector comprises a slot disposed on the backside surface and a tab disposed on the support, the slot adapted to accept the tab therethrough.

3) The article holding assembly of claim 2, wherein the slot comprises a main region adapted to accept the tab therethrough and a secondary region extending from the main region, the secondary region adapted to prevent the tab from being withdrawn therethrough.

4) The article holding assembly of claim 3, wherein a neck of the tab rests within the secondary region of the slot when the holder is secured to the support.

5) The article holding assembly of claim 1, wherein the housing comprises an upper portion having a first diameter and a lower portion having a second diameter, the second diameter being smaller than the first diameter.

6) The article holding assembly of claim 1, further comprising at least one aligned pair of apertures disposed on the backside surface, the at least one aligned pair of apertures adapted to accept a strap therethrough.

7) The article holding assembly of claim 1, further comprising:
a first pair of apertures disposed on the backside surface, the first pair of apertures spaced vertically and aligned horizontally;
a second pair of apertures disposed on the backside surface, the second pair of apertures spaced horizontally and aligned vertically;
wherein the first pair of apertures and the second pair of apertures are adapted to accept a strap therethrough.

8) The article holding assembly of claim 1, further comprising one or more condensation apertures disposed on the base of the holder.

9) The article holding assembly of claim 1, wherein the backside surface is offset from the housing.

10) The article holding assembly of claim 1, wherein the receptacle is disposed on the exterior surface of the holder.

11) The article holding assembly of claim 1, wherein the receptacle is disposed between the housing and the backside surface.

12) The article holding assembly of claim 11, further comprising a lid securable over the open upper end of the receptacle.

13) The article holding assembly of claim 1, wherein the connector comprises a first magnet disposed on the strap and a complementary second magnet disposed on the backside surface.

14) The article holding assembly of claim 1, wherein the strap comprises a first strap end and a second strap end, the first strap end and second strap end comprising a strap connector.

15) The article holding assembly of claim 14, wherein the strap connector comprises hook-and-loop fastening material.
